(19) United States
(12) Patent Application Publication
(10) Pub. No.: US 2017/0045189 A1
(43) Pub. Date: Feb. 16, 2017

(54) PRISMATIC WINDOW SHADE TO PROVIDE DAYLIGHT DIRECTING CONTROL

(71) Applicant: 10x Technology LLC, Libertyville, IL (US)

(72) Inventor: Robert M. Pricone, Libertyville, IL (US)

(21) Appl. No.: 15/265,953

(22) Filed: Sep. 15, 2016

Related U.S. Application Data
(63) Continuation-in-part of application No. 14/652,918, filed on Jun. 17, 2015, now abandoned.
(60) Provisional application No. 61/738,218, filed on Dec. 17, 2012.

(51) Int. Cl. F21S 11/00; G02B 5/20; G02B 1/04; E06B 9/42; G02B 5/04

(52) U.S. Cl. CPC F21S 11/007; E06B 9/42; G02B 5/045; G02B 1/04; G02B 5/208; E06B 2009/2417

(57) ABSTRACT

A roller type window shade for directing daylight onto the ceiling of an associated room in which the shade is positioned on a window of such room, the shade comprising a polymer film having a width commensurate with the width of the associated window and length commensurate with the length of the associated window, said film having at least one microprismatic area integrally formed as part of said film and extending along the width of said shade for redirecting daylight upwardly toward the ceiling of the associated room, and whereby the position of the shade can increase or decrease both the daylight directing and image visible area of the associated window.

### CROSS-REFERENCE TO RELATED APPLICATIONS

This application is a continuation-in-part of U.S. application Ser. No. 14/652,918, filed on Jun. 17, 2015, which, in turn, was a national stage entry of PCT/US2013/075842, filed on Dec. 17, 2013, which in turn, claimed priority to U.S. Application No. U.S. Provisional Patent Application No. 61/738218, filed on Dec. 17, 2012. All of these prior applications are incorporated herein by reference in their entirety.

### BRIEF DESCRIPTION OF THE DRAWINGS

FIG. 1 is a side perspective view of an embodiment disclosed herein.

FIGS. 2 and 2A is side schematic view of an embodiment disclosed herein.

FIG. 3 is a side schematic view of an embodiment disclosed herein illustrating incoming light on the embodiment.

FIG. 4A is a photograph of a room incorporating an embodiment of the shade disclosed herein.

FIG. 4B is a schematic view of an embodiment disclosed herein.

FIG. 5 is a schematic view of an embodiment disclosed herein.

FIG. 6 is a schematic view of an embodiment disclosed herein.

FIG. 7A and 7B are side schematic views of an embodiment disclosed herein.

FIG. 7C is a graph illustrating a relation of prism tile and upward ray angle.

FIG. 8 is side view of a dual shade embodiment.

FIGS. 9 and 9A are side schematic view of an embodiment disclosed herein.

FIG. 10 is a micrograph of an embodiment disclosed herein.

### DETAILED DESCRIPTION

Prismatic structures have been used in the past to direct sunlight into offices, retail stores, public buildings and homes to provide natural lighting and reduce the need for artificial lighting. Luxfer, circa 1910, was an example of this using glass prism structures in windows to direct light into work areas that benefited from natural lighting. Though the Luxfer product was an effective attempt to direct sunlight into buildings it is was expensive, heavy and limited in efficiency to the area of prisms installed in the structure. More recently Serra Solar has been test marketing a similar concept using a micro-prism polymeric product that is less expensive and can be attached to windows but once installed occupies a fixed area of the window. (See U.S. Patents assigned to Serra Solar U.S. Pat. No. 5,731,900 (Milner) and U.S. Pat. No. 5,880,886 (Milner); also see Chi Lin U.S. Pat. No. 8,107,164 (Tsai).

The need for natural lighting still exists but improvements to the original Luxfer concept have not met the needs of the building and architectural community. To address the need to bring daylight into work areas a microreplicated polymeric version of aspects of the Luxfer concept has been produced by SerraSolar Inc. of San Jose, Calif. Various prism geometries can be produced to redirect light at different angles but since the geometry is miniaturized by microreplication the product can be manufactured as a thin film, typically 350 to 400 μm thick and at much lower cost. This product has already been reduced to practice.

Because the prism film is not image transparent, an entire window cannot be covered if there is a need to see through the window. In order to solve this problem with prism films, and to simply and effectively change the area of the window that can redirect daylight, the invention herein comprises a prism film that can be incorporated in a roller type shade that can increase or decrease both the daylight directing and image visible area of the window. The novel shade can be operated manually or by remote control to vary the daylight directing area at will depending on the need for light or time of day, or the amount of through window visibility desired.

In one embodiment of the invention, a roller window shade comprises a film having at least one microprismatic area integrally formed on said film, said film to provide daylighting direction control for redirecting incoming daylight to the ceiling of an associated room in which the shade is located on a window in a wall of the associated room, and whereby the vertical position of the shade can increase or decrease both the daylight directing and image visible area of the associated window.

In one aspect of the invention, the roller window shade further includes at least two microprismatic areas on the shade, each microprismatic area having a different prismatic angular configuration for directing incoming sunlight to different locations of the ceiling. In another aspect of the invention, the roller window shade comprises a polymer having a width and length, and wherein said microprismatic area extends over the full width thereof and over a portion of the length thereof.

In another aspect of the invention, the roller window shade comprises different microprismatic areas that are spaced longitudinally from one another along the width of said shade.

In another aspect of the invention, the roller window shade comprises a polymer film and wherein the microprismatic area is integrally formed as a part of said film.

In another aspect of the invention, the roller window shade comprises a polymer film and wherein the microprisrnatic area is integrally formed as a part of said film, in which the polymer optionally comprises one or both of a UV absorber and an IR reflecting or absorbing layer, thereby to allow said shade to diminish damage caused by UV radiation and to effectively diminish IR heat from the associated room while still directing daylight entering the room.

In another aspect of the invention, the roller window shade comprises a polymer that is PMMA, the rnicroprisms have a height of about 0.250 mm and a pitch of 0.207 mm, said film having a total thickness of about 0.375 mm.

In one embodiment of the invention, a roller type window shade for directing daylight onto the ceiling of an associated room in which the shade is positioned on a window of such room comprises a polymer film having a width commensurate with the width of the associated windmill and a length commensurate with the length of the associated window, said film having at least one microprismatic area integrally formed as part of said film and extending along the width of said shade for redirecting daylight upwardly toward the ceiling of the associated room, and whereby the position of the shade can increase or decrease both the daylight directing and image visible area of the associated window.

In another aspect of the invention, the roller type window shade further includes at least first and second microprismatic areas on the shade, each microprismatic area having a different prismatic angular configuration for directing incoming sunlight to different locations of the ceiling.

A typical daylight prism has 45 degree angles with a height of 0.250 mm and a pitch of 0.207 mm. The overall thickness of the film is typically 0.375 mm thick and can be fabricated from PMMA, Polycarbonate, Polyurethane or various other polymers. To assure damaging UV radiation is controlled, UV absorbers can be added to the polymer substrates so only the visible wavelengths are transmitted. A further advantage of this concept includes adding IR reflecting or absorbing layers allowing the same product to effectively diminish IR heat from the room while still directing daylight.

Yet another advantage of this product is the ability to provide an embodiment having two different prismatic areas in the same shade for some regions of the shade. One prismatic area in the summer months would have prisms optimized with the solar elevation angle for that time of the year and have IR reflecting or absorbing layers to diminish IR heat from the room. A second prismatic area in the same shade would be optimized for the solar elevation angle in winter months and without the IR reflecting or absorbing layers to provide more radiant heat in the winter.

### EXPLANATION OF THE ILLUSTRATIONS

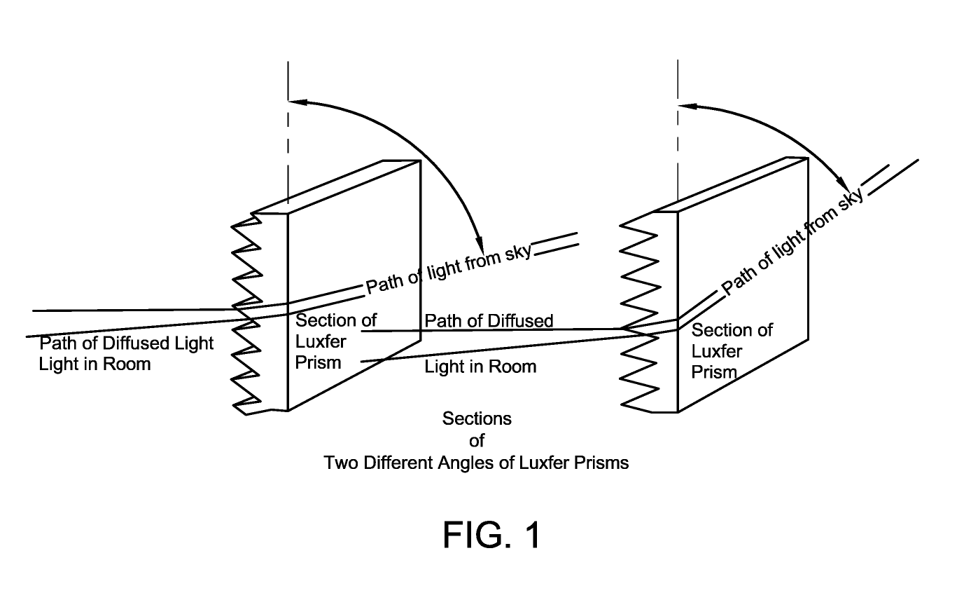

FIG. 1 is a catalog illustration circa 1910 of glass prism arrays manufactured by Luxfer that purported to direct sunlight into work areas.

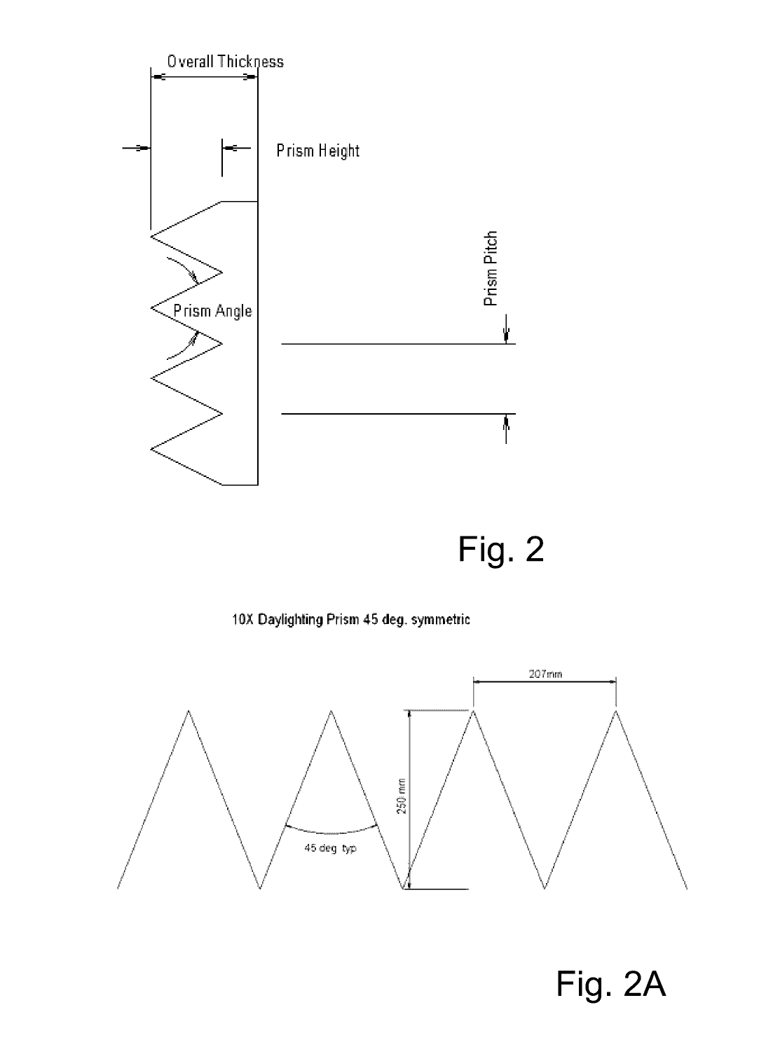

FIG. 2 illustrates prism angle, prism height, pitch and overall thickness of the film as those terms are used in this application.

FIG. 2a is an example of a microstructured product of the present invention that can be manufactured using a variety of polymers suitable for light transmission, flexibility and weatherability. Impact modified PMMA, polycarbonate and polyurethane are among the preferred materials.

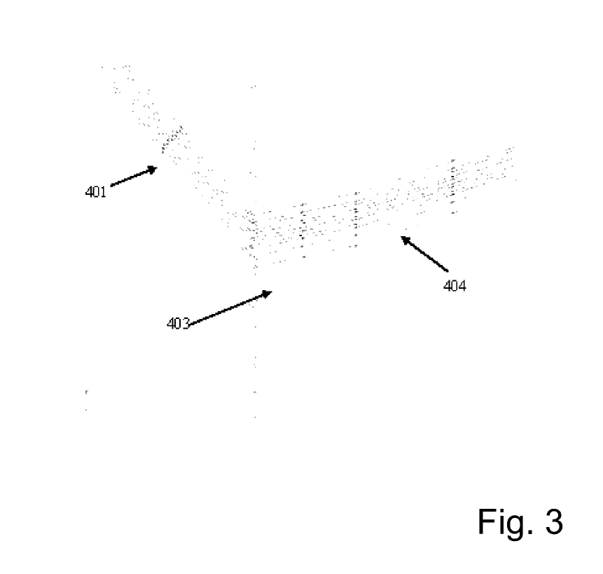

FIG. 3 represents a typical incident light ray path 401 for sunlight at a 50 degree elevation from the left passing through a microprism film product 403. As shown the sunlight ray 401 is being refracted 404 and redirected by the microprismatic film 403 into an adjacent room at a 20 degree angle. Variations in prism angle can provide different exit angles to allow light to be directed towards the ceiling or directly into the work area.

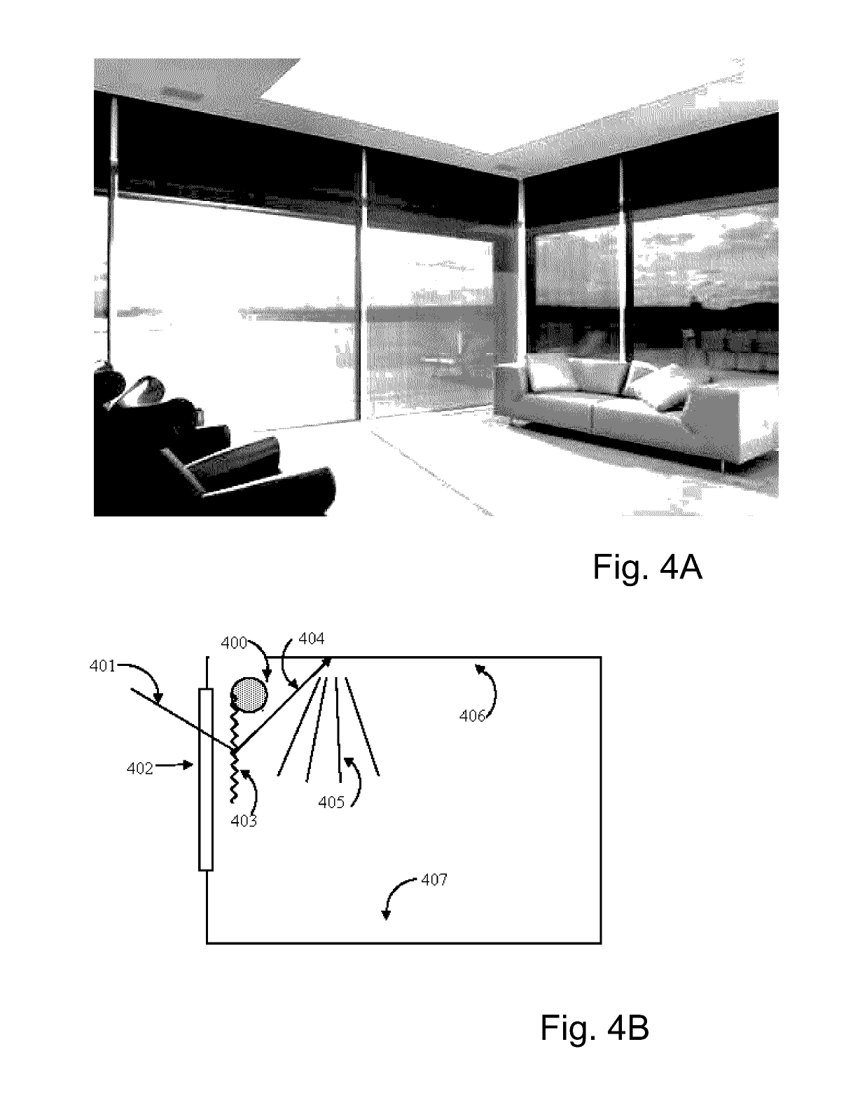

FIG. 4a Is an example of a room having microprismatic film shade provided as retractable allowing more or less daylight into the room as desired.

FIG. 4b is a functional example of the invention incorporating microprismatic film into a shade 400 that is variably adjustable in height allowing more or less daylight into the work area of the room 407 as desired. Sunlight rays such as 401 pass through a window 402 and are redirected as at 404 by the microprismatic film 403 in the shade 400 to the ceiling 406. The ceiling 406 diffuses the light 405 into the room 407. The roller shade 400 can be adjusted to any height to allow maximum redirection of the light towards the ceiling, partial distribution or none if maximum visibility through the window is required. The prism angle such as in FIG. 2 (or combination of prism angles) will direct light at different exit angles as required by the architect. IR reflecting or IR absorbing material can be incorporated in the polymer to reject heat while enhancing the level of daylight in the room. UV absorbing material can also be incorporated to reduce damage to furniture, carpeting and art while also enhancing the level of daylight in the room. The roller shade mechanism may be of well known standard manual spring operated, or electricity controlled design, and forms no part of the invention.

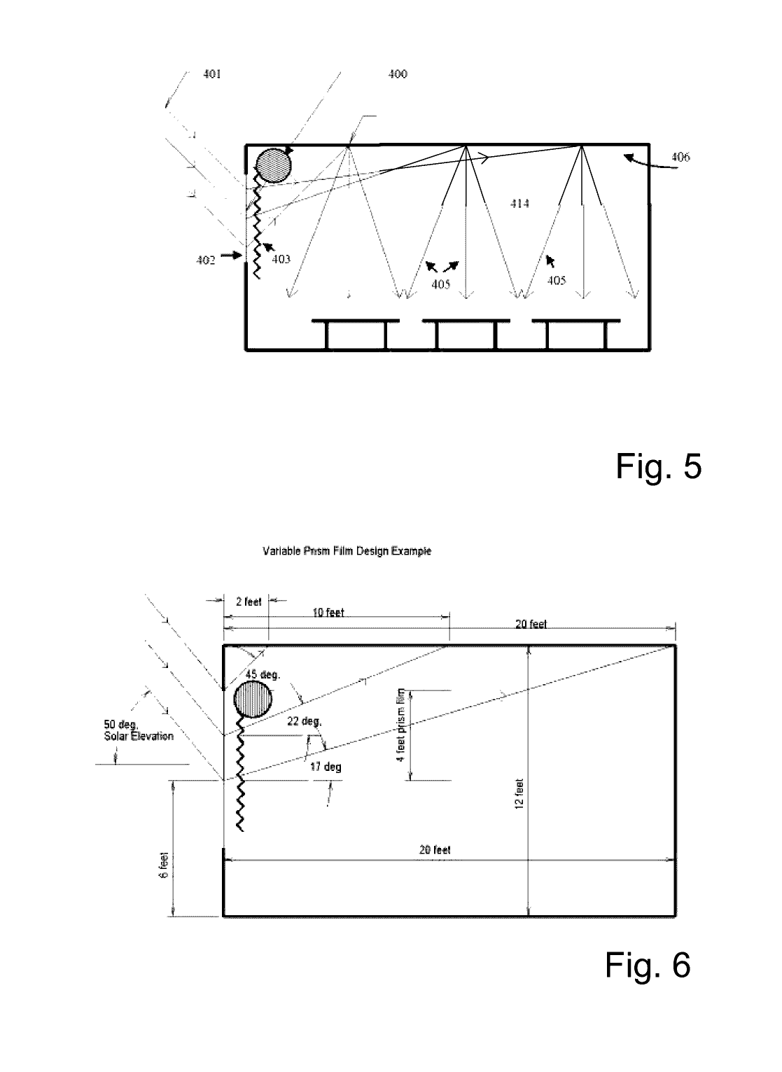

FIG. 5 illustrates how different variable prisms geometries may be placed at different heights on the film forming the window shade so that the ceiling is illuminated throughout the entire depth of the room. The ceiling is reflective white, and possibly contoured to scatter light below. Although the solar angle varies over day and season, static daylighting prism designs can be designed around the best average geometry. Zones with different prisms formed at different windows heights direct light toward different areas of the ceiling.

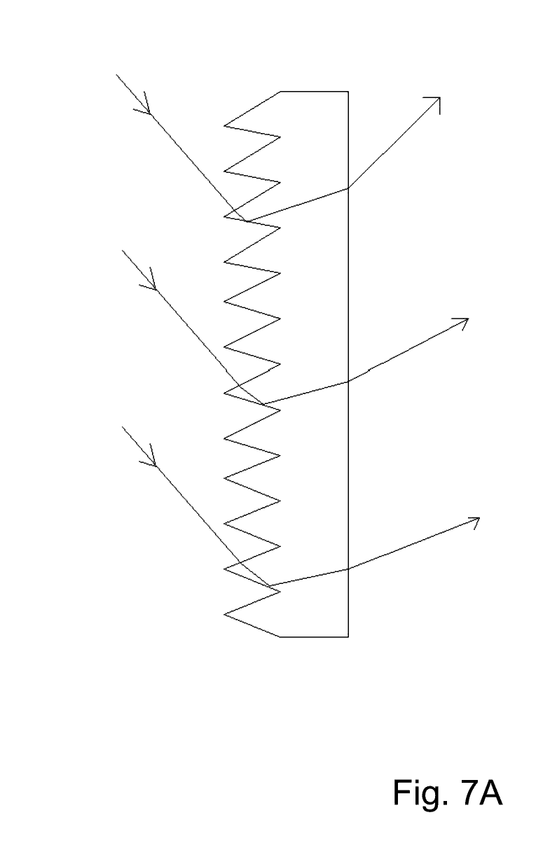

A specific design example for variable prism film that could broadly apply is generally illustrated at FIG. 6 and can be described as follows:
For most populated areas of the Northern hemisphere, the latitude is about 40 degrees. So at noon on the equinox, the solar elevation angle is at 50 degrees; this is the best estimate of “average” sun angle.
Many examples of south facing windows are in existence, and many newer window openings are taller, perhaps 6-10 feet above the floor and do not have important visual see thru function. An average office or work room depth is perhaps 20 feet.

FIG. 6 As an example of effective zones to distribute solar illumination, a plurality of upwardly redirected solar ray angles might be as shown. At the six foot elevation, just above eye-height, transmitted rays are at −17 degrees upward to be directed at the far back corner of the room. if the light at mid window height is to be redirected toward the middle of the ceiling, the refracted angle is ˜22 degrees. A practical angle for light redirection near the top of the window is −45 degrees.

So if the correct variable prisms are applied to a shade that covers the upper zones of a window as illustrated, sunlight will be redirected onto the inner 18 feet of the ceiling and thus illuminate the depth of the room.

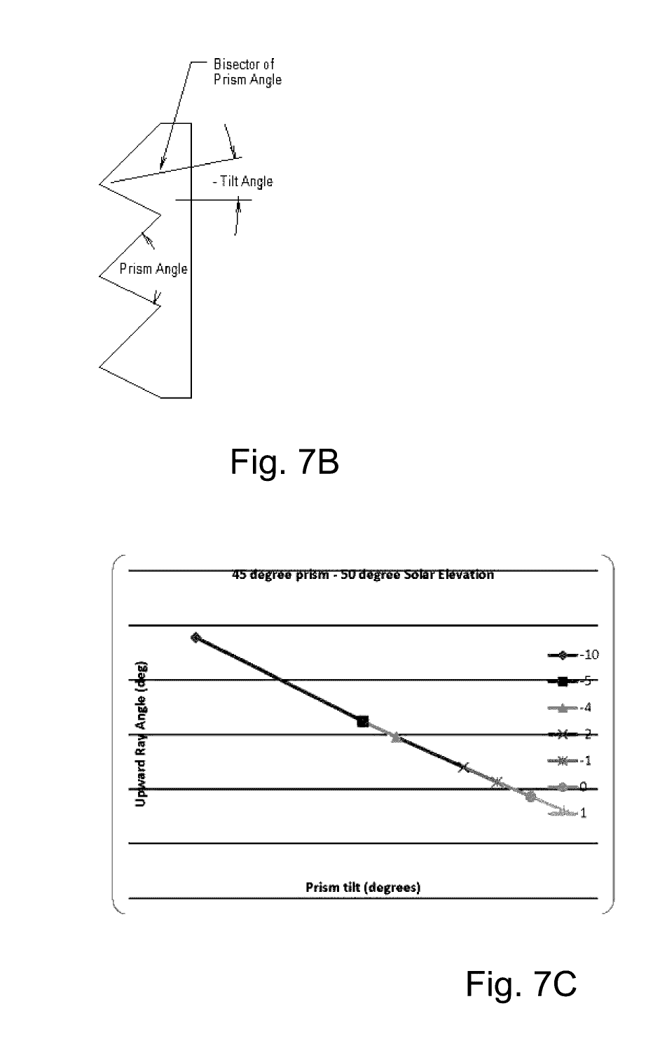

The 45-0 prism design as shown in FIG. 2 (a symmetric 45 degree prism angle, zero degree tilt angle) described above can be easily modified for this range of angles, where tilt angle is defined as illustrated in FIG. 7b. For a 45 degree prism tilted at 10 degrees (45+10 design), light incident at 50 degrees solar elevation will be directed upward at −48 degrees. Typical dimensions for this prism would be 0250 high, with a 0.207 mm pitch.

Total thickness of the substrate is typically 0.375 mm.

Polymeric microprisrnatic film as described herein can be manufactured by hot polymer embossing as described in Pricone U.S. Pat. No. 4,486,363. Using this process different zones of microprisms can be incorporated in the embossing belt allowing the polymeric microprismatic product to be manufactured continuously with zones repeating as necessary corresponding to the lengths necessary for use in the shade.

FIG. 7a For various tilt angles of the 45 degree prism light incident at the 50 degree solar elevation angle is directed upward as shown in FIG. 7a.

FIG. 7b defines prism tilt angle as the tilt of the prism bisector with respect to the film

FIG. 7c For the design example in FIG. 7a, the prism geometry should vary from About 45+1 at the lower edge to −45-2 at center and 45-9 at the upper edge. A range of prisms that include similar function as the series of Luxfer prism tiles are easily formed into micro-prism film strips or a continuously variable prism film.

In another embodiment, a dual-roller shade is provided, wherein two shades are provided to provide more efficient light refraction for different seasons such as summer and winter. Alternatively, even more shades can be provided to enhance the efficiency of light refraction throughout the year as the height in the sky of the sun's path through the sky changes as the seasons progress. Each of the roller shades are configured to cover all or substantially all of a window and a support is configured to be mounted above or beside the window (such as within the window cutout from the wall or the window frame) and hang on the interior or exterior side of the window.

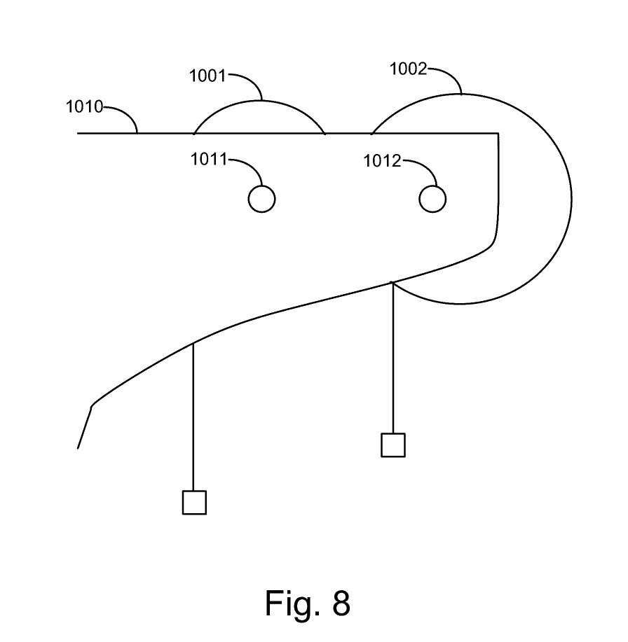

In an embodiment shown in FIG. 8, the dual-roller shade comprises a first roller shade 1001 that is coupled to a support 1010 on a first axis 1011, which is the axis nearest the window. The first roller shade 1001 is operable to be pulled down and rolled up by manually pulling and releasing, or by an electric motor, or by other methods and apparatuses such as pull-strings and pulleys. The dual-roller shade also comprises a second roller shade 1002 that is coupled to the support 1010 on a second axis 1012. The second roller shade 1002 is also operable to be pulled down and rolled up by manually pulling and releasing, or by an electric motor, or by other methods and apparatuses, such as pull-strings and pulleys.

The first roller shade 1001 has a series of grooves 1101 with a V-shaped cross-section that run horizontally along the first roller shade 1001 and open on the interior-facing side 1105 of the first roller shade 1001. The interior-facing side 1105 is opposed to the exterior-facing side 1106 of the roller shade 1001, which is flat in a vertical plane. Areas along the interior-facing side 1105 between openings of the grooves 1101 are flat in a vertical plane, i.e. vertically flat when the roller shade is installed and hanging down.

In an embodiment, the center angle of the grooves 1110 as measured at the inside angle of the V-shaped cross sectional shape (that is the angle formed by the intersection of the top and bottom portions of the groove) is 3 to 45 degrees, such as 5 to 30 degrees, or 8 to 20 degrees. In an embodiment, the center angle of the grooves 1110 varies as the grooves proceed down the first roller shade 1001, this results in a more severe angle of refraction for the incoming light focusing the light towards the ceiling of the room. The grooves may cover the entire length of the first roller shade 1001, or only the top 10 to 33%, or the top 33 to 99% of the total length of the first roller shade 1001.

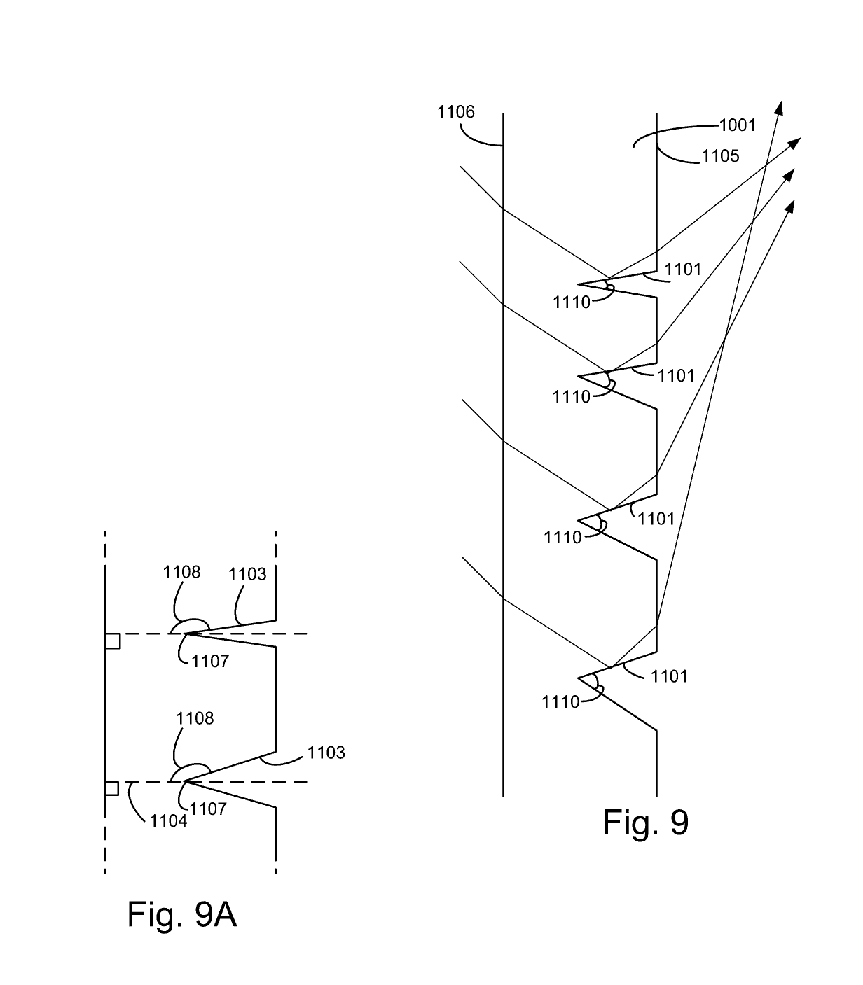

The top angle of the grooves 1108, is defined as the angle made by the top portion of the grooves 1103 relative to a horizontal line 1104 extending behind the vertex of the grooves 1107 and bisecting the vertex 1107 of the grooves. In an embodiment, as the roller shade is hanging down, the horizontal line 1104 is at a right angle to the exterior-facing side 1106. See FIG. 9A. In an embodiment, the top angle of the grooves 1108 is 210 degrees to 135 degrees, 180 to 115 degrees, or 160 degrees to 125 degrees.

The second roller shade also has a series of grooves with a V-shaped cross-section that opens on the interior-facing side of the second roller shade. The interior-facing side of the second roller shade is opposed to the exterior-facing side of the second roller shade, which is flat.

In an embodiment, the first roller shade 1001 is a winter shade and the second roller shade 1002 is a summer shade. The winter shade is the same except it differs from the summer shade in that at least a portion if not all of the center angles of the grooves 1110 are modified to be less acute respectively as the grooves proceed down the shades. For example, the first groove on the winter shade is less acute than the first groove on the summer shade, and the second groove on the winter shade is less acute than the second groove on the summer shade, and so forth. In an embodiment, the winter shade differs from the summer shade in that the top angle of the grooves 1108 is modified to be more acute respectively as the grooves proceed down the shades. For example, the difference between the respective center angle of the grooves 1110 and/or the top angle of the grooves 1108 between the winter and summer shades may be 3 to 12%, such as 4 to 10%, or 5 to 9%. In an embodiment, the center and or top angles of the grooves are adjusted to the arc of the sun at the 40^{th} degree north latitude.

In an embodiment, the winter shade also differs from the summer shade in that it is free of IR absorbers, and the summer shade contains IR absorbers, thereby providing more warmth from sunlight in the winter than in the summer.

In an embodiment, the winter shade also differs from the summer shade in that is contains no tint, or is less darkly tinted (has a greater overall light transmittance) than the winter shade.

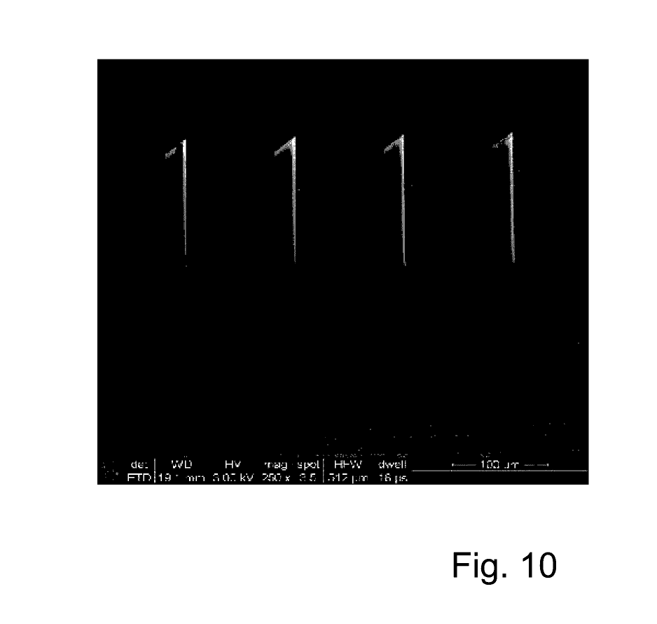

In an embodiment, such as is shown in FIG. 10, which is an actual SEM micrograph of the PMMA material with groves in it. The grooves do not have a sharp V-shaped bottom. Instead, the bottom of the groove is U-shaped or flat. In this case the vertex of the intersecting top and bottom portions of the grooves is at the middle of the flat section or the furthest cut-in portion of the U-shaped section. The dimensions of the groove openings on the top face of the material as pictured may range from 15 um to 30 um wide, such as 17 um to 25 um, or 18 um to 22 um, and they taper with various angles in the range disclosed above. The angles are dependent on desired refraction angle.

All angles and other measurements are determined as the respective roller shade is extended vertically toward the ground.

What is claimed is:

1. A roller window shade comprising a film having at least one microprismatic area integrally formed on said film, said film to provide daylighting direction control for redirecting incoming daylight to the ceiling of an associated room in which the shade is located on a window in a wail of the associated room, and whereby the vertical position of the shade can increase or decrease both the daylight directing and image visible area of the associated window.

2. The shade of claim 1, and further including at least two microprismatic areas on the shade, each microprismatic area having a different prismatic angular configuration for directing incoming sunlight to different locations of the ceiling.

3. The shade of claim 1 or 2, and wherein the shade comprises a polymer having a width and length, and wherein said microprismatic area extends over the full width thereof and over a portion of the length thereof.

4. The shade of claim 3 wherein the different microprismatic areas are spaced longitudinally from one another along the width of said shade.

5. The shade of claim 1, in which the shade comprises a polymer film and wherein the microprismatic area is integrally formed as a part of said film.

6. The shade of claim 5, in which the polymer optionally comprises one or both of
a UV absorber and an 1R reflecting or absorbing layer, thereby to allow said shade to diminish damage caused by UV radiation and to effectively diminish
IR heat from the associated room while still directing daylight entering the room.

7. The shade of claim 5, and wherein the polymer is PMMA, the microprisms have a height of about 0.250 mm and a pitch of 0.207 mm, said film having a total thickness of about 0.375 mm.

8. A roller type window shade for directing daylight onto the ceiling of an associated room in which the shade is positioned on a window of such room, the shade comprising a polymer film having a width commensurate with the width of the associated window and a length commensurate with the length of the associated window, said film having at least one microprismatic area integrally formed as part of said film and extending along the width of said shade for redirecting daylight upwardly toward the ceiling of the associated room, and whereby the position of the shade can increase or decrease both the daylight directing and image visible area of the associated window.

9. The shade of claim 8, and further including at least first and second microprismatic areas on the shade, each microprismatic area having a different prismatic angular configuration for directing incoming sunlight to different locations of the ceiling.

10. A multi-roller shade comprising:
a support and at least a first and a second roller shade coupled to the support;
the first roller shade comprising a first series of grooves that extend horizontally across an interior side of the first roller shade;
the second roller shade comprising a second series of grooves that extend horizontally across an interior side of the second roller shade;
the first series of grooves on the first roller shade having a first series of center angles formed by the intersection of top and bottom portions of the first series of grooves, and the first series of center angles is 3 to 45 degrees;
the second series of grooves on the second roller shade having a second series of center angles formed by the intersection of top and bottom portions of the second series of grooves;
wherein at least a portion of the second series of center angles is less acute respectively to the first series of center angles as the grooves proceed down the shades.

11. The multi-roller shade of claim 1, wherein the first roller shade is configured to efficiently refract light to a ceiling of a room during a winter season and the second roller shade is configured to efficiently refract light to a ceiling of a room during a summer season.

12. The multi-roller shade of claim 1, wherein a vertical space between openings for the series of grooves on the interior side of the first and second roller shades are flat in the vertical plane when the shade is hanging down vertically, and
the first roller shade is coupled to the support on a first axis and the second roller shade is coupled to the support on a second axis.

13. The multi-roller shade of claim 1, wherein the second roller shade comprises IR absorbers and the first roller shade is free of IR absorbers.

14. The multi-roller shade of claim 1, wherein the second series of center angles is 3% to 12% less acute respectively than the first series of center angles as the grooves proceed down the shades.

15. A multi-roller shade comprising:
a support and at least a first and a second roller shade coupled to the support;
the first roller shade comprising a first series of grooves that extend horizontally across an interior side of the first roller shade;
the second roller shade comprising a second series of grooves that extend horizontally across an interior side of the second roller shade;
the first series of grooves on the first roller shade having a first series of top angles defined by an angle made by a top portion of the grooves relative to a horizontal line extending behind a vertex of the grooves and bisecting the vertex of the grooves, and the first series of top angles is 210 degrees to 135 degrees;
wherein the second series of top angles is more acute respectively to the first series of top angles as the grooves proceed down the shades.

16. The multi-roller shade of claim 15, wherein the first roller shade is configured to efficiently refract light to a ceiling of a room during a winter season and the second roller shade is configured to efficiently refract light to a ceiling of a room during a summer season.

17. The multi-roller shade of claim 15, wherein a vertical space between openings for the series of grooves on the interior side of the first and second roller shades are flat in the vertical plane when the shade is hanging down vertically.

18. The multi-roller shade of claim 15, wherein the first roller shade is coupled to the support on a first axis and the second roller shade is coupled to the support on a second axis.

19. The multi-roller shade of claim 15, wherein the second roller shade comprises IR absorbers and the first roller shade is free of IR absorbers.

20. The multi-roller shade of claim 15, wherein the second series of center angles is 3% to 12% less acute respectively than the first series of center angles as the grooves proceed down the shades.
